(19) United States
(12) Patent Application Publication
(10) Pub. No.: US 2025/0100398 A1
(43) Pub. Date: Mar. 27, 2025

(54) BATTERY FRAME WITH CELL TO CHASSIS INTEGRATION

(71) Applicants: Miguel MERINO, Sterling Heights, MI (US); Venugopal GARIMELLA, Troy, MI (US); Gabriel CORDOBA, Rochester Hills, MI (US); MAGNA INTERNATIONAL INC., Aurora (CA)

(72) Inventors: Miguel MERINO, Sterling Heights, MI (US); Venugopal GARIMELLA, Troy, MI (US); Gabriel CORDOBA, Rochester Hills, MI (US)

(21) Appl. No.: 18/728,933

(22) PCT Filed: Jan. 19, 2023
(86) PCT No.: PCT/US2023/011133

§ 371 Date: Jul. 15, 2024

Related U.S. Application Data
(60) Provisional application No. 63/301,104, filed on Jan. 20, 2022.

(51) Int. Cl. B60L 50/64; B60K 1/04; B60L 50/60; B62D 21/15; B62D 25/20; H01M 10/613; H01M 10/625; H01M 10/6554; H01M 50/209; H01M 50/211; H01M 50/242; H01M 50/244; H01M 50/249; H01M 50/271

(52) U.S. Cl. CPC B60L 50/64; B60K 1/04; B60L 50/66; B62D 21/15; B62D 25/20; H01M 10/613; H01M 10/625; H01M 10/6554; H01M 50/209; H01M 50/211; H01M 50/242; H01M 50/244; H01M 50/249; H01M 50/271; B60K 2001/0438; H01M 2220/20

(57) ABSTRACT

A system for integrating a body-in-white (BIW) frame structure with a battery enclosure includes a BIW frame having a structural reinforcement member disposed around bottom portion. The battery assembly is disposed laterally inward from the structural reinforcement and is integrated with the BIW frame. The battery enclosure does not include lateral structural reinforcement, because lateral protection is provided by the BIW frame. The upper cover of the battery enclosure also serves as the floor of the BIW frame structure. The upper cover may be installed along with the rest of the BIW frame, with battery cells and a bottom tray of the battery being installed later, or the battery may be assembled as a module, with the battery being installed into an open space within the BIW frame thereby providing the floor.

### CROSS-REFERENCE TO RELATED APPLICATION

This PCT International Patent Application claims the benefit of U.S. Provisional Patent Application Ser. No. 63/301,104, filed on Jan. 20, 2022 and titled “Battery Frame With Cell To Chassis Integration,” the entire disclosure of which is hereby incorporated by reference.

### TECHNICAL FIELD

The present disclosure relates to passenger vehicle architecture. More particularly, the present disclosure relates to vehicle body architecture and battery enclosure structure.

### BACKGROUND OF THE DISCLOSURE

Passenger vehicles, and in particular electric vehicles, allow the vehicle to travel a certain distance before requiring that vehicle be re-charged or re-fueled. Traditional passenger vehicles with a gas-powered internal combustion engine are limited in range by the efficiency of the combustion engine and the amount of fuel that the vehicle can hold. Electric vehicles with a battery operated electric motor are limited in range by the efficiency of the motor and the charging capacity of the battery that powers the electric motor.

Traditional gas-powered vehicles include a vehicle body architecture, including a vehicle frame that may be referred to as a “body-in-white” (BIW) frame. The BIW frame is typically the state of the vehicle after the sections of the vehicle frame have been combined, where the BIW frame is in condition for additional components, such as the motor, engine, chassis, trim, or the like to be installed on the BIW frame to complete the vehicle.

In the case of electric vehicles, traditional BIW frame structure used for gas-powered vehicles may be generally re-used. The BIW frame provides structural integrity to the vehicle, such that the components may be attached while also providing crash protection to the components. Batteries are typically assembled separately and have their own enclosure that protects the inside of the battery, including the battery cells. Like an engine, batteries are typically a separate assembly that are later mounted to the BIW frame.

However, the combination of a battery assembly and the BIW frame results in redundancies in vehicle structure. In some cases, structure is duplicated, leading to reduced space for installation of the necessary internal components, as well as leading to increased weight, which is undesirable and can lead to reduced range and/or increased power consumption.

Accordingly, improvements can be made vehicle and battery structure.

### SUMMARY OF THE INVENTION

In one aspect, a vehicle structure is provided, the vehicle structure including: a body-in-white frame structure defining a vehicle body shape and providing structural support for the vehicle and mounting structure for vehicle components; and a battery assembly attached to a bottom portion of the body-in-white frame; wherein the bottom portion of the body-in-white frame includes a structural reinforcement member sized and configured to resist a vehicle crash impact; wherein the battery assembly is disposed laterally inward relative to the structural reinforcement member, wherein the structural reinforcement member of the body-in-white frame provides protection for the battery assembly; wherein the battery assembly includes a lower tray attached to an upper cover; wherein the upper cover defines a floor section of the body-in-white frame before or after integration of the battery assembly with the body-in-white frame.

In one aspect, the body-in-white frame does not include a vehicle floor, wherein the vehicle floor is provided by the upper cover.

In one aspect, the upper cover extends along a laterally facing surface of the structural reinforcement member of the body-in-white frame and also below a downward facing surface of the structural reinforcement member, wherein a single seal surface is provided for the upper cover below the structural reinforcement member.

In one aspect, the lower tray includes external cooling plates attached thereto.

In one aspect, external cooling plates are integrated into the lower tray.

In one aspect, the lower tray is configured to accommodate batteries in cell or module arrangement, wherein the batteries are in the form of at least one of pouch, prismatic, cylindrical or solid-state batteries.

In one aspect, the upper cover is configured to accommodate batteries in cell or module arrangement, wherein the batteries are in the form of at least one of pouch, prismatic, cylindrical or solid-state batteries.

In one aspect, the body-in-white frame includes an underbody in the form of a ladder frame without a floor panel, and wherein the upper cover defines a vehicle floor when assembled with the body-in-white frame.

In one aspect, the battery assembly is configured to accommodate a cooling system integrated into at least one of the lower tray and the upper cover or is configured to accommodate external cooling plates mounted thereto.

In one aspect, the body-in-white frame defines a vehicle underbody, and the battery assembly seals the underbody against water intrusion.

In one aspect, the body-in-white frame includes a plurality of structural reinforcement cells extending in the fore-and-aft direction and disposed outward from the battery assembly.

In one aspect, the battery assembly does not include structural reinforcement cells laterally adjacent the reinforcement cells of the frame.

In one aspect, the body-in-white frame includes the battery cover, and the battery cells are fixed to the lower tray to define a lower assembly, wherein the lower assembly is mounted to the frame including the battery cover.

In one aspect, one or more battery types is mounted to the upper cover such that the lower tray is attachable and removable from the frame while the one or more battery types remains attached to the upper cover.

In another aspect, a method of integrating a battery assembly with a body-in-white vehicle frame is provided, the method including: providing a body-in-white frame structure having a bottom portion defining a structural reinforcement; integrating an upper cover of a battery assembly into the body-in-white frame structure and defining a floor section of the body-in-white frame structure with the upper cover; and enclosing a plurality of battery cells between a bottom tray of the battery assembly and the upper cover of the battery assembly; wherein the battery assembly is disposed laterally inward relative to the structural reinforcement of the body-in-white frame structure such that the battery assembly is protected by the structural reinforcement, wherein the battery assembly does not include a lateral reinforcement structure; wherein the upper cover is attached to the body-in-white frame structure before or after attachment of the bottom tray to the upper cover.

In one aspect, the lower tray includes external cooling plates attached thereto.

In one aspect, external cooling plates are integrated into the lower tray.

In one aspect, the lower tray is configured to accommodate batteries in cell or module arrangement, wherein the batteries are in the form of at least one of pouch, prismatic, cylindrical or solid-state batteries.

In one aspect, the upper cover is configured to accommodate batteries in cell or module arrangement, wherein the batteries are in the form of at least one of pouch, prismatic, cylindrical or solid-state batteries.

In one aspect, the battery assembly is assembled prior to installation with the frame structure and includes the upper cover attached to the lower tray.

In one aspect, the battery module seals an underbody portion of the frame structure against water intrusion.

In one aspect, the upper cover is sealed to a lower surface of the structural reinforcement and also defines a floor section of the frame structure when assembled with the frame structure.

In one aspect, the upper cover is attached to the frame prior to assembling the lower tray with the upper cover.

In one aspect, the battery cells are attached to the upper cover, wherein the lower tray is removable from the upper cover after assembly with the upper cover, wherein the plurality of battery cells remain attached to the upper cover.

In one aspect, the battery cells are attached to the lower tray, wherein the lower tray and battery cells are removable from the upper cover after assembly wherein the upper cover remains attached to the frame.

In one aspect, a removable casing encloses the battery cells along with the lower tray prior to assembly of the lower tray with the upper cover, wherein the removable casing protects the battery cells prior to assembly, and wherein the removable casing is removed from the lower tray during assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partially exploded perspective view of an integrated battery and body-in-white (BIW) frame structure;

FIG. 2A is an exploded view of a traditional battery and frame assembly, illustrating undesirable redundancies in the floor area and side-impact protection area;

FIG. 2B is a partial cross-sectional view of the traditional battery and frame assembly, illustrating undesirable redundancies in the floor area and side-impact protection area;

FIG. 3A is an exploded view of the BIW frame and battery according to as aspect of the disclosure;

FIG. 3B is partial cross-sectional view of the BIW frame and battery of FIG. 3A in an assembled state according to various assembly procedures of the disclosure, with the illustrated assembled state applicable to each assembly method;

FIG. 4 is another exploded view of the BIW frame and battery according to an aspect of the disclosure;

FIG. 5 is a perspective view illustrating one aspect of an assembly procedure for integrating the battery and the BIW frame according to an aspect of the disclosure;

FIG. 6 is a perspective view illustrating another aspect of an assembly procedure for integrating the battery and the BIW frame according to an aspect of the disclosure;

FIG. 7A is a perspective view illustrating yet another aspect of an assembly procedure for integrating the battery and the BIW frame according to an aspect of the disclosure; and

FIG. 7B is a top view of the BIW frame of FIG. 7A.

### DESCRIPTION OF THE ENABLING EMBODIMENT

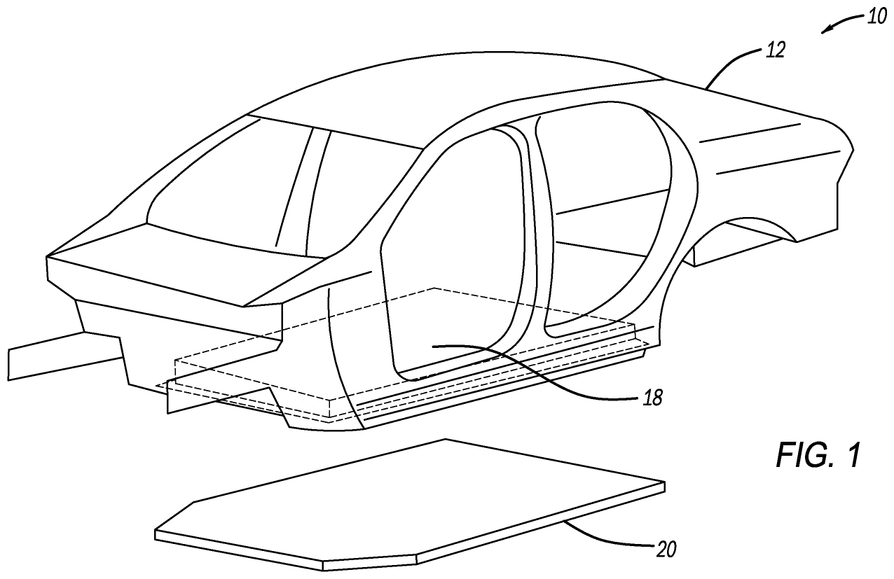

Referring to the Figures, a system 10 for integrating an EV battery with the structure of a vehicle is provided. As shown in FIG. 1, the system 10 includes a “body-in-white” (BIW) frame 12 and a battery enclosure assembly 14 (shown partially exploded), which may also be referred to generally as battery 14 (internal battery components not shown in FIG. 1). The battery 14 and frame 12 may be integrally assembled such that structural redundancies are eliminated. As shown in FIG. 1, integrated floor/battery cover 18 and lower tray 20 of the battery assembly 14 are shown in an exploded view, with the battery cover 18 shown in its assembled position relative to the BIW frame 12, thereby defining the floor structure of the vehicle rather than such structure being provided as part of the BIW frame 12. It will be appreciated that the battery enclosure assembly 14, or battery 14, may include a variety of components, including internal battery components such as battery cells and cooling structures. The battery 14 may include various ports to accommodate cooling mechanisms, signals, power, and the like. The integration of the battery 14 with the BIW frame 12 will be described in further detail below.

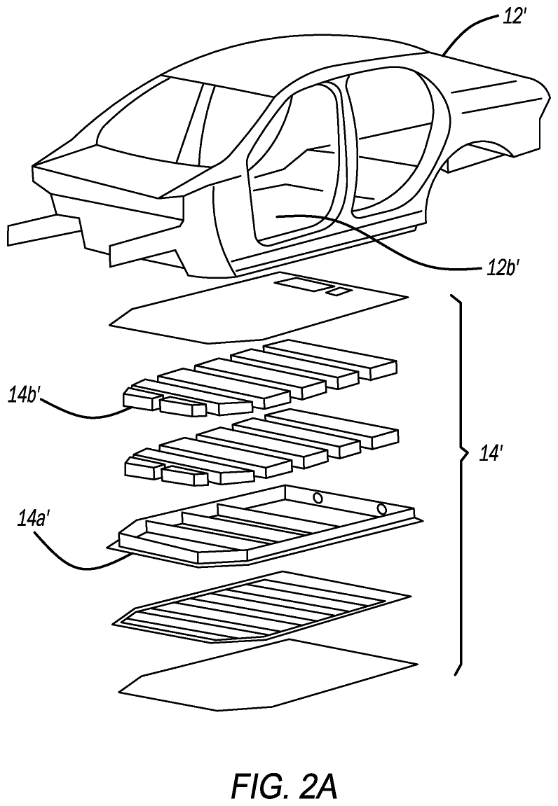

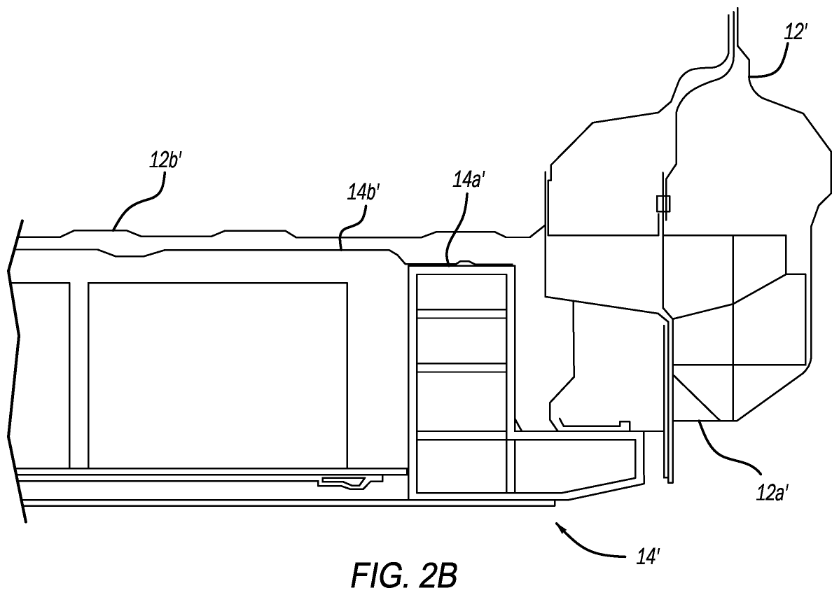

With reference to FIGS. 2A and 2B, an example of a traditional duplicate structure design is shown, where a BIW frame 12′ is shown in cross-section, providing side impact protection structure 12a′. The side impact protection structure 12a′ defines a plurality of cells extending in the fore-and-aft direction, as shown. The battery assembly 14′ is a separate housing, which also include side impact protection structure 14a′. The side impact protection structure 14a′ of the battery 14′ is shown laterally inward relative to protection structure 12a′, and also includes a plurality of cells extending in the fore-and-aft direction, as shown. The battery 14′ includes a cover 14b′ which extends below the floor 12b′ of the frame 12′. Thus, there is an illustrated redundancy with the BIW frame 12′ both at the side (impact protection) and at the top (floor definition) of the battery 14′.

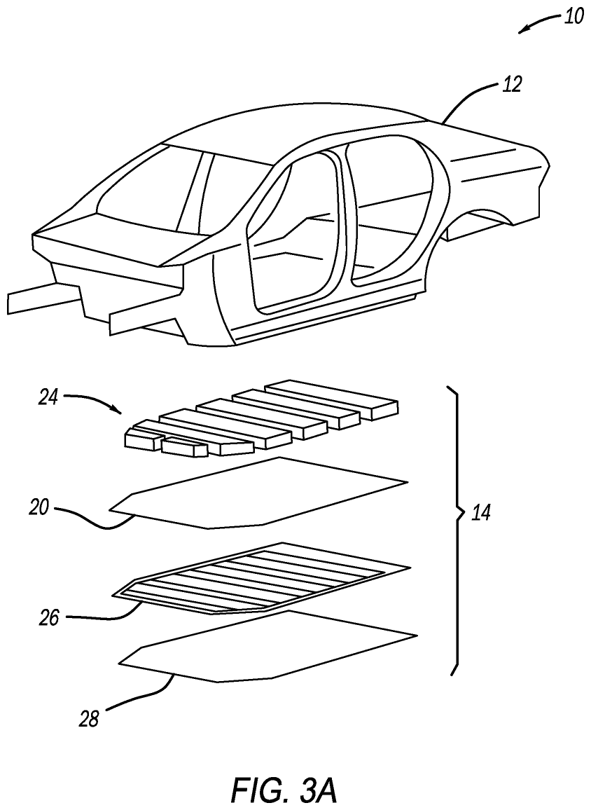

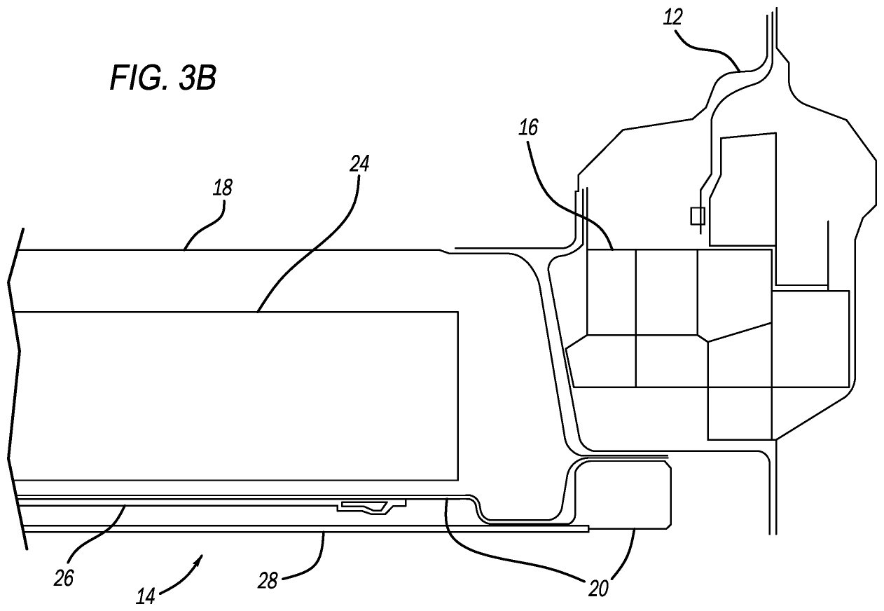

With reference to FIGS. 3A and 3B, an integrated arrangement of the battery 14 and frame 12 is shown, with reduced structural redundancies. As shown in FIG. 3A and 3B, the frame 12 includes side impact structure 16 that is disposed laterally outward relative to the battery 14. As shown, a plurality of cells are formed in the fore-and-aft direction of the frame 12 within structure 16. The battery 14 here does not include side impact structure. As shown, the battery does not include the protection cell structure. The battery 14, in particular the battery cells 24, are still enclosed within the battery 14. The battery 14 includes a cover 18 that extends across the top of battery cells 24, and further extends downward to define sides of the battery 14. These sides are disposed laterally inward relative to the side impact structure 16, and do not include protection cells. The cover 18 is joined with a lower tray 20, which supports the battery cells 24. The lower tray 20 may include multiple layers of material, including cooling components such as external cooling plates that run below the battery cells 24.

It will be appreciated that the battery cells 24 shown in FIG. 3B may be interpreted as being attached to either of the upper cover 18 or lower tray 20, as described herein.

As shown, the lower tray 20 does not extend upward to define a sidewall or the like. Indeed, the structural protection for the side of the battery 14 is provided by the frame 12. Thus for a generally given frame size, the battery 14 has an increased internal volume, allowing for additional battery cells 24 or other components, if necessary. Furthermore, the battery enclosure has reduced weight by eliminating the robust side protection cell structure.

The cover 18 is described herein as being part of the battery 14. However, the cover 18 also makes up at least a portion of the floor of the frame 12. As shown in FIG. 3B there is no redundancy for the horizontal cover/frame area, unlike in FIG. 2A and 2B.

The cover 18 (which makes up at least a portion of the vehicle floor when assembled) is shown extending down along the side of the side support structure 16 of the frame 12, and further extends laterally outward along the bottom of the structure 16. Thus, there is horizontal overlap with the side structure 16 below at least a portion of the side structure 16. This floor design with the illustrated upper cover 18 attaches to a lower surface of the support structure 16 and creates a single sealed interface along a single seal surface disposed below the support structure 16, which provides improved leak resistance. As shown, the upper cover 18 and lower tray 20 and bottom surface of support structure 16 are stacked together at the same lateral position along this single seal surface. The bottom tray 20 is likewise disposed below the structure 16 of the frame 12. The tray 20 may be sealingly attached to the cover 18 and/or structure 16 of the frame 12, thereby protecting against leaks from the battery as well as ingress of dirt/debris/water or the like into the battery 14. The bottom tray 20 may include a cell extending fore-and-aft, as shown, disposed below the side structure 16 of the frame 12, and which provides overall support for shape of the bottom frame 20 (which does not include sidewalls to provide such support).

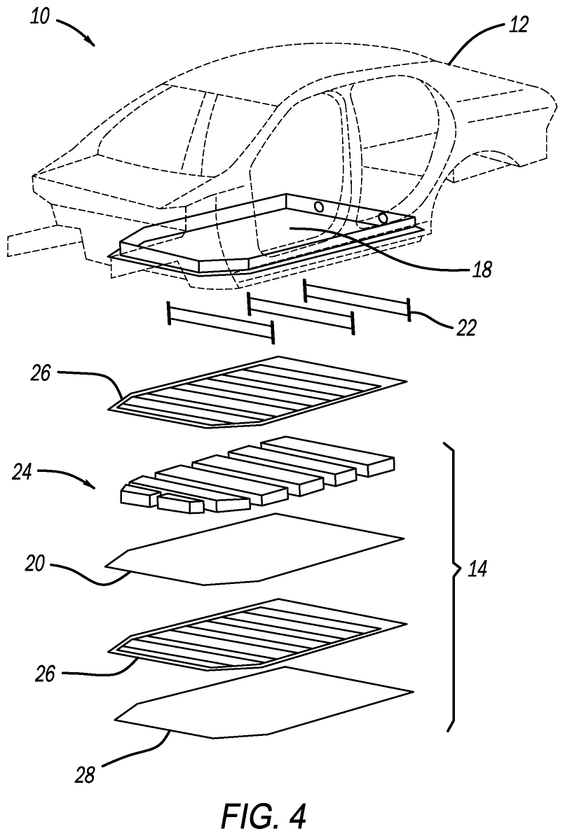

FIG. 4 provides further detail regarding the assembled components of the battery 14 of this design. The cover 18 is disposed at the top of the battery 14, and may also be considered as the vehicle floor. Put another way, the floor of the vehicle or frame 12 serves as the cover or upper plate/lid of the battery 14, and the cover 18 serves as the floor of the vehicle or frame 12. As shown, the cover 18 includes downwardly extending sidewalls and therefore is in the shape of a downwardly directed open box like structure.

The battery 14 may further include one or more cross members 22 that are disposed within the battery 14. In one aspect, the cross members 22 are disposed between battery cells 24 (which may also be in the form of battery modules). The cross members 22 may be used when necessary to meet specific stiffness requirements and satisfy pole crash standards. In one aspect, the cross members 22 may be excluded if not necessary. The specific arrangement of the cross members 22 (number, spacing, etc.) between the battery cells 24 may vary according to specific design needs. In one aspect, the cross members 22 may be welded to the cover 18. The cross-members 22 may extend laterally between the downwardly extending sidewalls of the box-like shape of the cover 18, thereby providing further structural support to the battery 14 and cover 18.

The lower tray 20 generally operates to support and hold the battery cells 24 from below (and cross members 22 or other internal components). In addition to being welded to the upper cover 18, the cross members 22 are also attached to the lower tray 20 when assembled, and are attached in the cross car direction (laterally) to distribute the battery mass and lower impact loads with the frame 12. The illustrated cross members 22 are applicable to each assembly aspect and procedure provided herein. The tray 20 extends across the frame 12 in both the cross car and fore-and-aft direction. As discussed above, the lower tray 20 is attachable in a sealed manner to the bottom of the frame 12, as shown in FIG. 3B. The cover 18 attaches to the tray to enclose the battery cells 24 within the battery 14. The cover 18 extends continuously across the top of the battery and downward along the sides of the battery 14, overlapping the side structure 16 of the frame 12, such that the frame 12 provides impact resistance and protection for the battery. In this arrangement, the cover 18 itself does not provide substantial side impact protection, in that it does not include the plurality of structural cells extending along the sides.

In one aspect, as shown in FIG. 3B, the sides of the cover bend laterally outward and the outer edge portion of the cover 18 is sandwiched vertically between the lower tray 20 and the bottom surface of the frame structure 12. This stacked interface is positioned above a closed structural cell defined by the lower tray 20. While a single closed structural cell is illustrated for the lower tray 20, additional cells may be provided.

A cooling plate 26 is disposed below the lower tray 20 and adjacent the bottom surface of the lower tray 20. The cooling plate 26, shown in the form of an external cooling plate that is assembled and placed adjacent the lower tray 20, is part of the overall thermal management system, and is disposed near the battery cells 24, with the lower tray 20 disposed vertically therebetween, to provide thermal management for the heat of the battery cells 24. In another approach, the cooling plate 26 may be integrated into the structure of the lower tray 20, and the lower tray 20 itself may provide thermal management by cycling coolant adjacent to the battery cells.

In one aspect, a protection plate 28 may be disposed below the cooling plate 26 and the lower tray 20 and attached to the tray 20, such that the protection plate 28 and tray 20 combine to define an overall lower structure with the cooling plate 26 therein. The protection plate 28 may provide higher strength and may be a thicker sheet metal to protect from bottom impacts. Thus, the protection plate 28 may serve as a guard or the like for the cooling plates 26 and/or the lower tray 20 that is supporting the battery cells 24.

In one aspect, depending on further battery development, additional or alternative cooling plates 26 (or other cooling structure) may be placed above the battery cells 24, as shown in the exploded view of FIG. 4. Such cooling structures 26 may be attached to the cover 18 (which also serves as the floor of the vehicle/frame 12). In this approach, a gap may still be present between the lower tray 20 and protection plate 28, with the protection plate 28 providing protection and acting as a guard for the lower tray 20 that supports the battery cells 24. In one approach, the additional or alternative cooling plates 26 may be integrated into the cover 18, with the cover 18 providing thermal management, similar to the alternative discussed above for the lower tray 20. It will be appreciated, therefore, that FIG. 4 illustrates two sets of upper and lower cooling plates 26, but that not all of the cooling plates may be provided. In one approach, cooling may be provided both at the top and the bottom of the battery, with the cooling plates 26 being disposed at the top or the bottom and the tray 20 or cover 18 having the integrated in cooling channels to provide the cooling on the other side. In one aspect, some rows of the battery cells 24 may have cooling plates 26 or cooling channels provided at the top, with other having cooling plates 26 or integrated channels at the bottom. Thus, various combinations of the above options may be used to provide the desired cooling for the battery cells 24.

In one aspect, the tray 20 and protection plate 28 may be combined into a single structure, with alternative impact and energy absorption, such as honeycomb panels, molded beads, structural foam, etc. In the case of a single structure, cooling may be provided by one of the various cooling arrangements described above.

The above described integrated arrangement of the battery 14 and the BIW frame 12 may be accomplished in different ways. For example, the mode and order of assembly, or creation of sub-assemblies or modules, may vary.

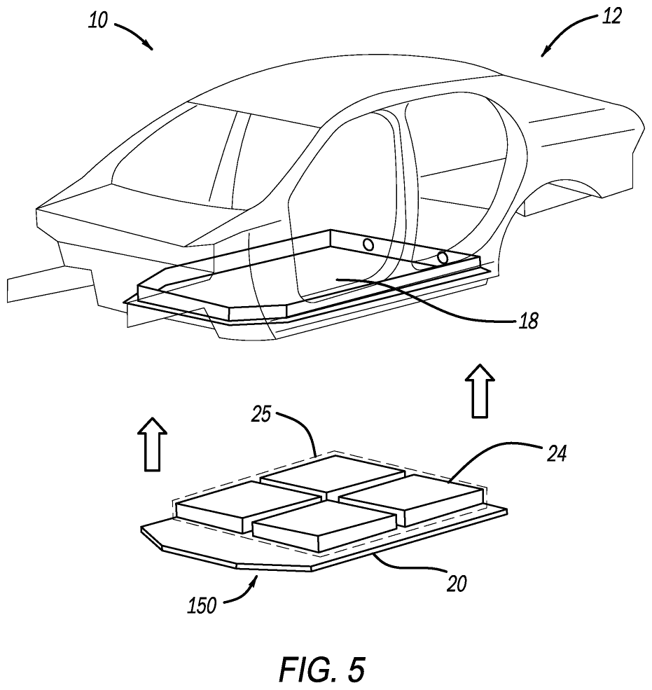

In one aspect, shown in FIG. 5, the battery cells 24 (or modules) may be attached or installed to the lower tray 20. The other components, like the cooling plate 26 and the protection plate 28, may likewise be assembled to the lower tray 20. In this approach, the battery cells 24 are mounted to the tray 20 ahead of installation with the frame 12 and cover 18.

In this approach, the cells 24 are generally exposed and not covered by the cover 18. Thus, an uncovered battery assembly 150 is provided. In this approach, a casing 25, such as a reusable casing, may be placed over the exposed battery cells 24 for protecting the battery cells 24 during handling and prior to installation with the cover 18 and frame 12. The casing 25 is removed prior assembling the lower tray 20 and battery cells into to the cover 18 and the frame 12. The cover 18, in this aspect, is installed as the floor of the BIW frame 12, and is provided along with the overall frame 12. Put another way, the BIW frame 12 may be interpreted as having a closed floor (which constitutes the cover 18), to which the above described assembly can be attached.

The tray 20, in this approach, carries the battery cells 24 thereon. The tray 20 may therefore be installed to the bottom of the frame 12, thereby inserting the battery cells 24 up into the open space/cavity defined by the already installed and provided cover 18. The tray 20 is attached to the frame 12 and encloses the battery cells 24 within the already attached cover 18 and the frame 12.

With the tray 20 installed, the tray 20 can be later removed from the frame 12, which also removes the battery cells 24 along with the tray 20, due to the cells having been attached and carried with the tray 20. Thus, the battery cells 24 can then be easily removed from the tray 20 for service, replacement, or the like. Alternatively, a new assembly of tray 20 and battery cells 24 may be installed, which may differ from the initial assembly of cells 24 and tray 20 but with the same type of mounting connections.

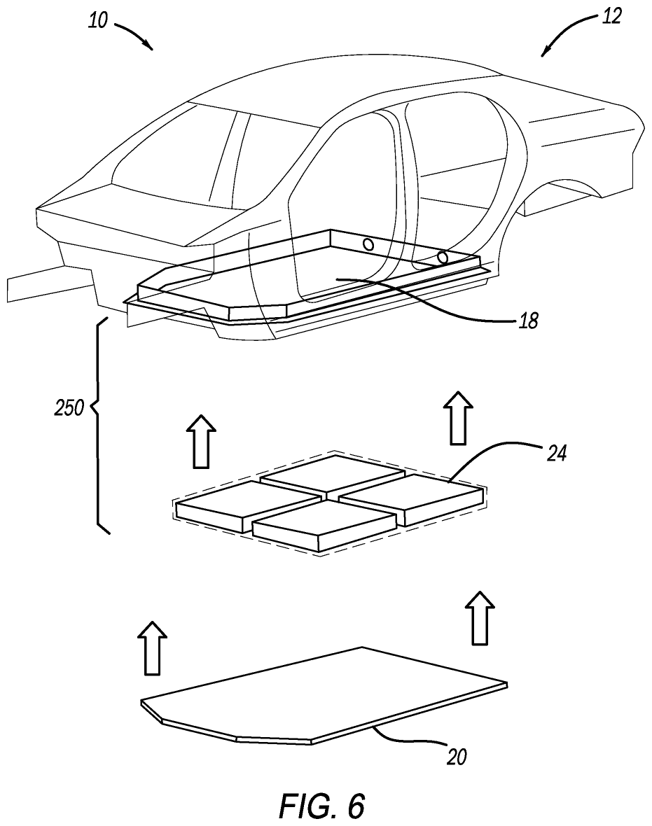

With reference now to FIG. 6, in another aspect, the battery cells 24 may be attached to the cover 18, which has been attached to the frame 12 prior to attaching the battery cells 24 and is part of the frame 12. In this approach, an assembly 250 of the cells 24 and cover 18 is therefore defined prior to installing the tray 20. The tray 20 in this approach does not have the battery cells 24 attached thereto. Similar to the above, the tray 20 may be attached to the frame 12, thereby enclosing the cells 24 between the cover 18 and the tray 20 and sealing the cells 24 therein. Removal of the tray 20 from the frame 12 in this approach retains the batteries 24 and cover 18 in their assembly 250, and provides access to the battery cells 24 without removing the battery cells 24 from the vehicle structure. In this approach, the tray 20 may be removed and replaced 20 without necessarily disturbing or moving the battery cells 24 relative to the frame 12. It will be appreciated that the protection plate 28 and/or cooling plates 26 may be pre-assembled with the tray 20 in this approach or attached following installation of the tray 20 with the frame 12.

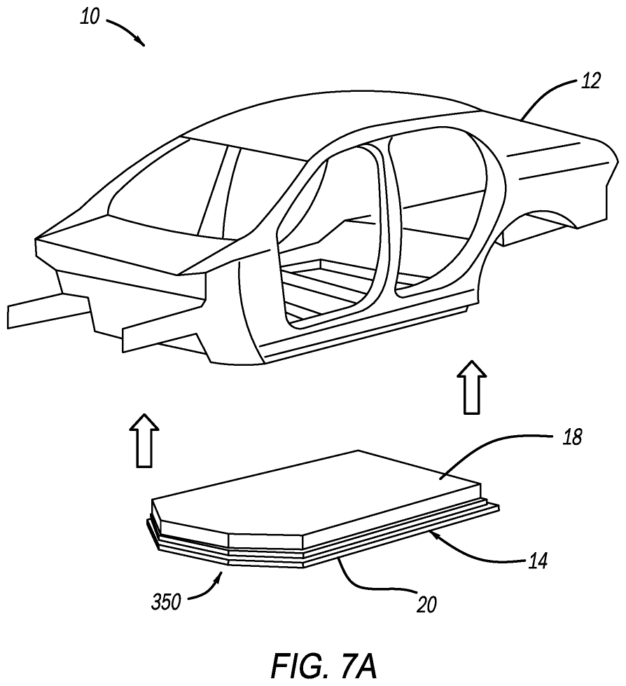

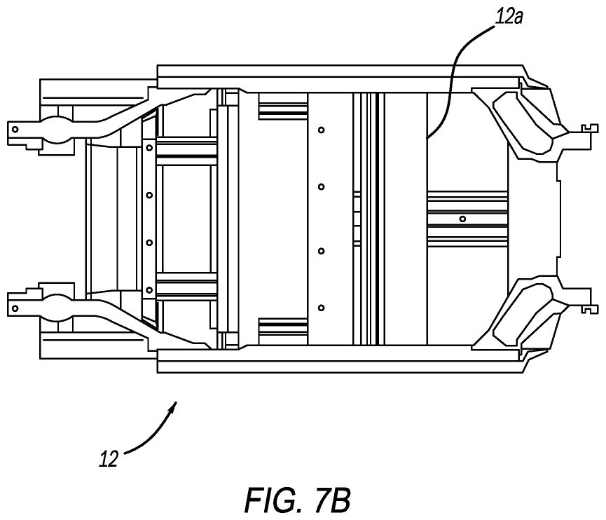

In yet another aspect, shown in FIG. 7A and 7B, the battery 14 may be provided in a generally fully assembled state, including the cover 18 to define a full assembly 350. It will be appreciated that the reference to a “full” assembly is to distinguish relative to the previously described assemblies regarding the cover 18, cells 24, and lower tray 20, but that other components to be added may not necessarily be part of the assembly 350, and the use of the term full shall not be interpreted as limiting in that regard. For instance, the cooling plates 26 or protection plate 28, among other components, could be part of the assembly 350 or provided later. In the approach of FIG. 7A and 7B, the frame 12 may be different than the previously described BIW frame 12. For example, in the above description, the floor of the BIW frame 12 acted as the cover 18, and was part of the BIW frame structure. In the BIW frame 12 of FIG. 7A and 7B, the frame is designed as a space frame in the mid-floor area, such that the floor has essentially been eliminated from the underbody of the vehicle structure.

The BIW frame 12 may in this case be in the form of a ladder frame, with open spaces where the floor structure is typically located, with laterally extending stabilizing structure extending across the BIW frame 12 to create a ladder-like structure 12a, as shown more clearly in FIG. 7A and 7B.

In this aspect, the battery 14 is provided as a fully-assembled module or assembly 350, including the cover 18 already to the tray 20, with the cells 24 already installed within the battery 14 module assembly in one of the various layouts described above. The fully assembled form 350 of the battery 14 of FIG. 7A and 7B is similar to the ultimately assembled form of the assembled batteries 14 of FIGS. 5 and 6 after assembly is completed and the tray 20 has been attached to the frame 12.

In this aspect, the battery 14 does not include the structural reinforcement, similar to the above-described layouts. The BIW frame 12 still includes the structural reinforcement aspects, as it is designed in this manner to receive the non-structurally reinforced battery 14.

The battery 14 in this aspect is separate from the BIW frame 12 during the BIW/frame assembly process, and is then mounted and permanently installed to the BIW frame 12 at the customer assembly line stage of manufacturing.

This approach of FIG. 7A and 7B allows for easy assembly of the battery cells 24 and other internal electrical components. The battery cells 24 and other internal components may be installed to the cover 18 (which will become the floor of the vehicle when the battery 14 is later installed) in a generally “upside-down” manner, such that later maintenance may be performed by removing the tray 20, thereby providing access to the battery cells 24 and other components, which can remain attached to the cover 18, similar to the approach of FIG. 6.

In this approach, the battery cells 24 are less exposed to damage or the like during handling and installation, because they are enclosed by cover 18. Thus, during the installation of the battery 14 onto the frame, the battery cells 24 can remain protected. In this approach, a casing, such as the casing 25 of FIG. 5, need not be removed and the battery cells 24 need not be exposed even for a short time.

Additionally, by installing the cover 18 to the tray 20 prior to installation with the BIW frame 12, the battery 14 can be leak tested more easily. Additionally, the battery 14 is sized to be received in the floor space of the BIW frame 12, such that when received, the battery 14 assembly seals to the corresponding structure of the BIW frame 12 to prevent water ingress into the vehicle body.

The battery 14 assembly further provides lower impact protection to the vehicle via the lower tray 20, which seals against the cover 18 to provide a leak-tight overall enclosure. As mentioned above, the upper cover 18 can provide the various mounting surfaces and structure for the various internal electrical components, including the battery cells 24, such that the internal components remain attached to the vehicle while still allowing the bottom tray 20 to be removed for maintenance.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility.

1. A vehicle structure comprising:
a body-in-white frame structure defining a vehicle body shape and providing structural support for the vehicle and mounting structure for vehicle components; and
a battery assembly attached to a bottom portion of the body-in-white frame;
wherein the bottom portion of the body-in-white frame includes a structural reinforcement member sized and configured to resist a vehicle crash impact;
wherein the battery assembly is disposed laterally inward relative to the structural reinforcement member, wherein the structural reinforcement member of the body-in-white frame provides protection for the battery assembly;
wherein the battery assembly includes a lower tray attached to an upper cover;
wherein the upper cover defines a floor section of the body-in-white frame when the battery assembly is integrated with the body-in-white frame.

2. The vehicle structure of claim 1, wherein the body-in-white frame does not include a vehicle floor, wherein the vehicle floor is provided by the upper cover.

3. The vehicle structure of claim 1, wherein the upper cover extends along a laterally facing surface of the structural reinforcement member of the body-in-white frame and also below a downward facing surface of the structural reinforcement member, wherein a single seal surface is provided for the upper cover below the structural reinforcement member.

4. The vehicle structure of claim 1, wherein the lower tray is configured to receive external cooling plates mounted thereto or includes an integrated cooling system.

5. The vehicle structure of claim 1, wherein the lower tray is configured to accommodate various battery types in cell or module arrangements, including at least one of a pouch, prismatic, or solid-state battery type.

6. The vehicle structure of claim 1, wherein the body-in-white frame includes an underbody in the form of a ladder frame without a floor panel, and wherein the upper cover defines a vehicle floor when assembled with the body-in-white frame.

7. The vehicle structure of claim 1, wherein the battery assembly is configured to accommodate a cooling system integrated into at least one of the lower tray and the upper cover or is configured to accommodate external cooling plates mounted thereto.

8. The vehicle structure of claim 1, wherein the body-in-white frame defines a vehicle underbody, and the battery assembly seals the underbody against water intrusion.

9. The vehicle structure of claim 1, wherein the body-in-white frame includes a plurality of structural reinforcement cells extending in the fore-and-aft direction and disposed outward from the battery assembly.

10. The vehicle structure of claim 9, wherein the battery assembly does not include structural reinforcement cells laterally adjacent the reinforcement cells of the frame.

11. The vehicle structure of claim 1, wherein the body-in-white frame includes the upper cover, and the battery cells are fixed to the lower tray to define a lower assembly, wherein the lower assembly is mounted to the frame including the upper cover.

12. The vehicle structure of claim 1, wherein one or more battery types is mounted to the upper cover such that the lower tray is attachable and removable from the frame while the one or more battery types remains attached to the upper cover.

13. A method of integrating a battery assembly with a body-in-white vehicle frame, the method including the steps of:
providing a body-in-white frame structure having a bottom portion defining a structural reinforcement;
integrating an upper cover of a battery assembly into the body-in-white frame structure and defining a floor section of the body-in-white frame structure with the upper cover; and
enclosing a plurality of battery cells between a bottom tray of the battery assembly and the upper cover of the battery assembly;
wherein the battery assembly is disposed laterally inward relative to the structural reinforcement of the body-in-white frame structure such that the battery assembly is protected by the structural reinforcement, wherein the battery assembly does not include a lateral reinforcement structure;
wherein the upper cover is attached to the body-in-white frame structure before or after attachment of the bottom tray to the upper cover.

14. The method of claim 13, wherein the battery assembly is assembled prior to installation with the frame structure and includes the upper cover attached to the lower tray.

15. The method of claim 14, wherein the battery module seals an underbody portion of the frame structure against water intrusion.

16. The method of claim 13, wherein the upper cover is sealed to a lower surface of the structural reinforcement and also defines a floor section of the frame structure when assembled with the frame structure.

17. The method of claim 13, wherein the upper cover is attached to the frame prior to assembling the lower tray with the upper cover.

18. The method of claim 13, wherein the battery cells are attached to the upper cover, wherein the lower tray is removable from the upper cover after assembly with the upper cover, wherein the plurality of battery cells remain attached to the upper cover.

19. The method of claim 13, wherein the battery cells are attached to the lower tray, wherein the lower tray and battery cells are removable from the upper cover after assembly wherein the upper cover remains attached to the frame.

20. The method of claim 19, wherein a removable casing encloses the battery cells along with the lower tray prior to assembly of the lower tray with the upper cover, wherein the removable casing protects the battery cells prior to assembly, and wherein the removable casing is removed from the lower tray during assembly.
